(19) United States
(12) Patent Application Publication
(10) Pub. No.: US 2023/0082184 A1
(43) Pub. Date: Mar. 16, 2023

(54) TWO-STEP OSCILLATION SOURCE LOCATOR

(71) Applicant: GENERAL ELECTRIC COMPANY, Schenectady, NY (US)

(72) Inventors: Honggang WANG, Clifton Park, NY (US); Gang ZHENG, Surrey (CA); Shaopeng LIU, Clifton Park, NY (US); Manu PARASHAR, Redmond, WA (US); Mohammadreza Maddipour FARROKHIFARD, Schenectady, NY (US); Aravindhan VADIVEL, Schenectady, NY (US)

(21) Appl. No.: 17/493,993

(22) Filed: Oct. 5, 2021

Related U.S. Application Data
(60) Provisional application No. 63/243,811, filed on Sep. 14, 2021.

(51) Int. Cl. G06N 5/02; G06N 5/04; H02J 13/00

(52) U.S. Cl. CPC G06N 5/022; G06N 5/04; H02J 13/00002; H02J 13/00001; H02J 13/00034; H02J 2203/20; H02J 3/381

(57) ABSTRACT

Provided is a system and method for detecting source(s) of oscillation on a power grid. In one example, the method may include receiving measurements from one or more sensors on a power grid, the measurements including data of an oscillation within the power grid, determining, via execution of one or more machine learning model, a candidate set of power system components disposed on the power grid that are candidates for being the source(s) of the oscillation, identifying, via execution of an optimization model, a component from among the candidate set of power system components which is the source (e.g., location, controller type, and/or asset type) of the oscillation, and displaying, via a user interface, information about the identified component.

### CROSS-REFERENCE TO RELATED APPLICATIONS

The present application claims the benefit of U.S. Provisional Patent Application No. 63/243,811, filed on Sep. 14, 2021, in the United States Patent and Trademark Office, the entire disclosure of which is hereby incorporated by reference for all purposes.

### BACKGROUND

Oscillations in a power system can be categorized as free oscillations and forced oscillations. Free oscillations typically have a constant amplitude and frequency and occur due to natural interaction (e.g., elastic forces, inertia, etc.) among dynamic devices in the system. On the contrary, forced oscillations cause the system to oscillate with a frequency other than its natural frequency and are typically caused by an external force, also referred to as a driving force. Forced oscillations can have a negative impact on the power system. For example, forced oscillations may prevent proper estimation of mode and mode shape if not properly accounted for. As another example, low-frequency oscillations that are negatively damped will have a magnitude that will grow and consequently cause power outages and breakup in the system. Therefore, detecting forced oscillations and finding the source of the forced oscillations is critical to maintaining a stable power system.

With the large-scale integration of renewable energy systems (RES) in the power grid along with a continual increase in variable loads with intermittent characteristics, instances of forced oscillations have increased significantly. Among the renewable energy systems, wind energy systems are a major contributor of forced oscillations primarily due to the fluctuations in wind speed and disturbances that are caused by doubly fed induction generator wind turbine (DFIG-WT) control strategies.

Many algorithms exist for detecting the “occurrence” of a forced oscillation in the power system. However, identifying a source of the forced oscillation is considerably difficult. Power systems often cover entire metropolitan areas, counties, states, and even countries. These power systems may include many energy sources, generators, transmission lines, and the like, which can each cause oscillations. Accordingly, what is needed is an approach to identify a root cause (e.g., source location) of an oscillation in a power system.

### SUMMARY

The example embodiments are directed to two-step approach for locating the source of an oscillation in a power system. The first step may be referred to as an “explorative” step. Here, one or more machine learning models may receive measurements from elements disposed on the power grid such as sensors, etc., and predict or otherwise detect an area on the grid which is the source of the oscillation. Here, the area may include a bus-level or sub-station level location. Meanwhile, a second step, also referred to as an “exploitative” step, may refine the detected area into a target source (i.e., a specific component) within the area that is the source/responsible for the oscillation. As an example, the first step may identify a rough area (e.g., a bus, or a few buses, etc.) on the grid where the source of the oscillation is located, while the second step may identify a particular device or system (e.g., generator name, etc.) that is connected to the bus that is the cause of the oscillation.

In an aspect of an example embodiment, a method may include receiving measurements from one or more sensors on a power grid, the measurements including data of an oscillation within the power grid, determining, via execution of one or more machine learning models, a candidate set of power system components disposed on the power grid that are candidates for being a source of the oscillation, identifying, via execution of an optimization model, a target component from among the candidate set of power system components which is the source of the oscillation, and displaying, via a user interface, information about the target component.

Other features and aspects may be apparent from the following detailed description taken in conjunction with the drawings and the claims.

### BRIEF DESCRIPTION OF THE DRAWINGS

Features and advantages of the example embodiments, and the manner in which the same are accomplished, will become more readily apparent with reference to the following detailed description taken in conjunction with the accompanying drawings.

FIG. 1 is a diagram illustrating a power system for delivering electricity to a customer in accordance with an example embodiment.

FIG. 2 is a diagram illustrating a network topology of an electrical grid.

FIG. 3 is a diagram illustrating a system including an enhanced disturbance management (EDM) module.

FIGS. 4A and 4B are diagrams illustrating a two-step approach for identifying a source of an oscillation in a power system according to example embodiments.

FIGS. 5A and 5B are diagrams illustrating a process of training and deploying a machine learning model in accordance with example embodiments.

FIGS. 6 and 7 are diagrams illustrating various examples of machine learning architectures in accordance with example embodiments.

FIG. 8 is a diagram illustrating an example of the optimization model in accordance with an example embodiment.

FIG. 9 is a diagram illustrating a method of identifying a source of an oscillation in a power system in accordance with an example embodiment.

FIG. 10 is a diagram illustrating a computing system for use in the examples herein in accordance with an example embodiment.

Throughout the drawings and the detailed description, unless otherwise described, the same drawing reference numerals will be understood to refer to the same elements, features, and structures. The relative size and depiction of these elements may be exaggerated or adjusted for clarity, illustration, and/or convenience.

### DETAILED DESCRIPTION

In the following description, specific details are set forth in order to provide a thorough understanding of the various example embodiments. It should be appreciated that various modifications to the embodiments will be readily apparent to those skilled in the art, and the generic principles defined herein may be applied to other embodiments and applications without departing from the spirit and scope of the disclosure. Moreover, in the following description, numerous details are set forth for the purpose of explanation. However, one of ordinary skill in the art should understand that embodiments may be practiced without the use of these specific details. In other instances, well-known structures and processes are not shown or described in order not to obscure the description with unnecessary detail. Thus, the present disclosure is not intended to be limited to the embodiments shown, but is to be accorded the widest scope consistent with the principles and features disclosed herein.

Oscillations of electric systems can be classified into two categories. The first category is free oscillation which results from a negative damping ratio of power systems. It could also be called negative damping oscillation. A well-known and accepted explanation mechanism for free oscillations are based on the complex torque analysis method proposed by DeMello and Concordia in 1969. When the reactance of transmission system is large or power output of generators is high, the negative damping torque produced by lagging phase of quick excitation circuit counteracts the original positive damping of generators' damping windings. This will lead to negative damping ratio of power grids and cause a power oscillation with increasing amplitude. Reducing transmission power of tie lines or installing equipment which enhances damping torque through phase compensation has proved to be effective for suppressing negative damping power oscillation.

The second type of oscillation is a forced oscillation. Power resonance of a generator can be provoked when a frequency of a small periodic disturbance occurring at the power system is equal or close to the system's natural frequency. This kind of power oscillation is characterized by a fast oscillation start and rapid decay after losing the oscillation source. Some researchers have demonstrated that periodic disturbances of excitation circuit, turbine speed governor system, and active power load could stimulate forced power oscillation. Separating the periodic disturbance sources from the system is the most effective countermeasure to eliminate its influence quickly.

Usually, the oscillation source is implicitly defined as a physical device which causes oscillations following a certain mechanism. Examples of causes of sustained oscillations include, but are not limited to, an excitation system, a diesel engine, synchrotron as a cyclic load, a control valve, a turbo pressure pulsation, a governor control, asynchronous parallelizing of synchronous generators, improper parameters for a steam turbine controller, and the like.

The wide area management system (WAMS), or the like, in a power system can be used to successfully capture system oscillation events such as poorly damped natural oscillations and forced oscillations. There is a need for better approach to identify the root cause of an observed oscillation event for further mitigation actions. However, locating the source of an oscillation is not an easy task. Prior approaches to identifying the source of a forced oscillation lack accuracy. Meanwhile, the example embodiments provide a new/novel approach for accurately detecting the source location (i.e., the asset or assets) of an oscillation on the power grid. In particular, the example embodiments are directed to a two-step approach described that first finds a rough geographical location of the source e.g., bus level, substation level, etc.), and then refines the rough geographical location into a single component or a multiple components that are the cause of the oscillation. The first step may rely on one or more machine learning models which reduce the entire grid into a few possible candidates. The second step may rely on an optimization algorithm that finds the most likely source location from among the few possible candidates identified by the one or more machine learning models.

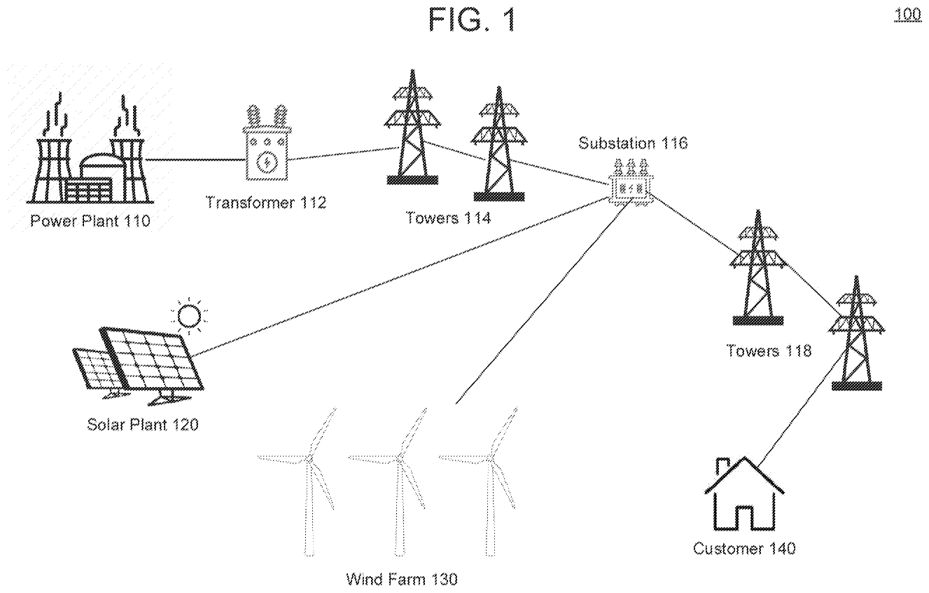

FIG. 1 illustrates a power delivery system 100 showing components that can facilitate the generation of power and the process of delivering power (e.g., delivering energy, electricity) to customer premises 140. Electric power can be generated at a power generation facility (power plant 110), passed to a transformer 112 and then carried by transmission power lines 114 to substations 116 having transformers. A local distribution system of smaller, lower-voltage transmission lines 118 and substations carry power to the customer premises 140. In the example of FIG. 1, the power delivery system 100 may also include renewable sources of power including a solar plant 120 and a wind farm 130. As in the case of the power plant 110, the solar plant 120 and the wind farm 130 can generate electric power which is passed to a point on the grid (e.g., substation 116, etc.) and carried to the customer premise 140 just as the power from the power plant 110. In operation, any of these sources, lines, or other components can be the cause of an oscillation in the power delivery system 100.

A variety of facilities can generate electric power including both power plants and renewable energy sources. For example, power generation facilities (e.g., power plant 110, etc.) can include power plants that burn coal, oil, or natural gas. As another example, power generation facilities can include nuclear power plants, renewable sources of energy (e.g., solar plant 120, wind farm 130, etc.) such as hydroelectric dams, wind turbines, and solar panels, and the like. The location of these power generation facilities, and their distance from end users, can vary widely.

The electricity that is generated by the power generation facilities may be stepped up or stepped down by transformers (e.g., transformer 112) which may be located at power plant substations adjacent to (and connected via power lines to) the power plant. For example, a transformer may be a step-up transformer that will “step up” the voltage of the electricity. When power travels through power lines (e.g., metallic wires that conduct electricity), some of that power is wasted in the form of heat. The power loss is proportional to the amount of current being carried. Power companies keep the current low and compensate by stepping up the voltage. After the voltage is stepped up, the electricity is typically carried over long distances by high voltage power transmission lines, typically supported and elevated by transmission towers (e.g., transmission towers 114 and 118) that can be of various dimensions, materials, and heights.

The voltage may be gradually reduced by step-down transformers as the electricity approaches customer premises. Transmission substations contain step-down transformers that reduce the voltage of the electricity. The electricity can then be distributed on lower-voltage power lines. A typical transmission substation can serve tens of thousands of customers. The electricity leaving transmission substations can travel through power lines to distribution substations. Distribution substations contain step-down transformers that further reduce the voltage of electricity and distribute the power to cities and towns through main power lines, which can serve hundreds of customers. Distribution lines carry lower voltage power to clusters of homes and businesses, and are typically supported by wooden poles. Of note, power lines can also be buried under the ground. Of note, substations can contain a variety of other equipment, including switches, breakers, regulators, batteries, etc.

The voltage from a branch line can further be reduced by transformers that are mounted on poles that connect customer premises through a service drop power line. Customer premises (e.g., customer premise 140, etc.) can be of any type and variety. Customer premises can be a residential customer premises, such as residential houses. Customer premises can be an industrial customer premises, such as factories. Customer premises can be commercial customer premises, such as an office building. If a particular customer premises has a heavier load (e.g., has a higher demand for power), then a larger transformer, instead of a pole transformer, might service that particular customer premises.

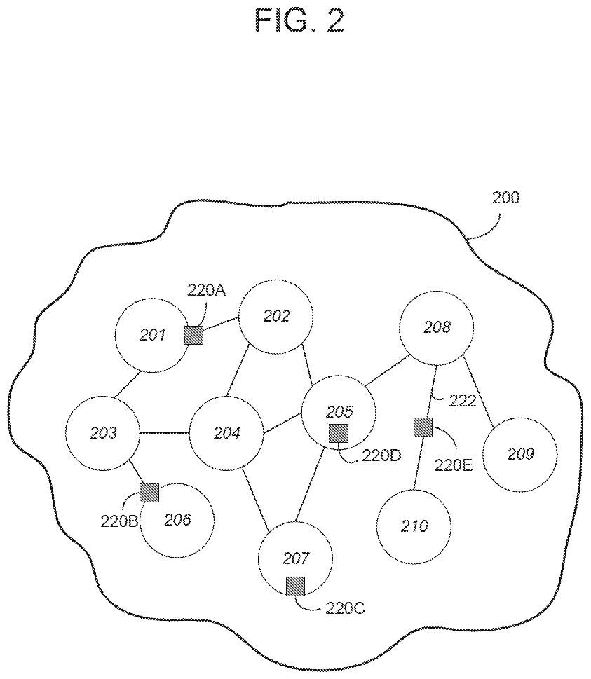

FIG. 2 depicts an illustration of a power grid system 200 (e.g., an electrical grid) comprising multitudes of nodes 201-210. In this example, a node may represent a power generation facility, transmission substation, a distribution substation, and the like, and is intended to convey that such facilities and substations can be interconnected. In the examples herein, a node may be referred to as a “power system node.” The power grid system 200 can follow a structural topology, influenced by factors such as budget, system reliability, load demand (demand for power), land, and geology. The structural topology in many cities and towns, for example many of those in North America, tends to follow a classic radial topology. This is a tree-shape network wherein power from larger voltage lines and substations radiates out into progressively lower voltage lines and substations until the customer premises are reached.

A substation receives its power from a power generation facility, and the power may be stepped down with a transformer and sent through lines that spread out in all directions across the countryside. These feeders carry three-phase power and tend to follow major streets near the substation. As the distance from the substation grows, the fanout continues as smaller laterals spread out to cover areas missed by the feeders. This tree-like structure grows outward from the substation, but a single power failure can render inoperable entire branches of the tree. For reliability reasons, there are often unused backup connections from one substation to a nearby substation. This backup connection can be enabled in case of an emergency, such that a part of a substation's service area can be fed by another substation in case of any power failure events. Redundancy allows line failures to occur and power to be rerouted while workmen restore to service damaged or deactivated components. Neighboring power utilities also typically link their grids, thereby assisting one another to maintain a balance between power generation supply and loads (e.g., customer demand). Other topologies can be mesh topologies, looped systems (mostly found in Europe) and ring networks.

The result can be an interconnected power grid system 200 that can form complex networks of power plants and transformers connected by hundreds of thousands of miles of high-voltage transmission lines. While these interconnections can be useful in situations, the danger or risk can comprise the possibility that a shutdown in one sector could rapidly spread to other sectors, leading to massive power failures in a wide area.

In the example of FIG. 2, disposed within the power grid system 200 are measurement devices 220A-220E. Throughout a power network, a variety of sensors, monitoring devices and measurement devices (collectively referred to herein as “measurement devices”) can be located at one or more nodes (e.g., nodes 201-210), in between nodes on lines, and the like, and can be used to provide monitoring data related to power flow measurements, or monitor the condition of one or more aspects of a power grid system. The measurement devices 220A-220E may be deployed within, or adjacent to, power transmission components (e.g., generating units, transformers, circuit breakers), including at substations. In some examples, the measurement devices 220A-220E can also be deployed along distribution lines.

The measurement devices 220A-220E may include sensors that measure a range of parameters such as magnitude and phase angle of voltage, current, harmonic distortion, real and reactive power, power factor, and fault current. Examples of some sensors include, but are not limited to, voltage and current sensors, PMUs, transformer-Metal Insulated Semiconducting (MIS) gas in oil sensors, circuit breaker sulfur hexafluoride density sensors, conductor temperature and current sensors that record overhead transmission conductor temperatures and current magnitudes, overhead insulator leakage current sensors, Transmission Line Surge Arrester (TLSA) sensors, and the like.

In the example of FIG. 2, the power grid system 200 may include the measurement devices 220A-220E located in various parts (e.g., such as nodes) throughout the grid. The measurement devices 220A-220E can be coupled via a network of transmission lines, as well as through wireless and wired communications mediums (e.g., cellular, ethernet, etc.). For example, a measurement device 220E can be coupled via a transmission line 222 from a network of transmission lines associated with the nodes 201-210. Furthermore, a subset of the measurement devices can be associated with a sector of the power grid system 200.

In example embodiments, the reliability of the power grid system 200 can be facilitated through the use and analysis of the data received from measurement devices 220A-220E and monitoring of system conditions that are then communicated to a central control center, where a combination of automated actions and human decision assist in striving to ensure that the power grid system 200 is stable and balanced. For example, a measurement device may include a phasor measurement unit (PMU) which can capture data of a disturbance event. PMUs typically have a naming convention based on PMU information which is defined by a regional transmission authority. Meanwhile, power system nodes 201-210 have a naming convention based on utility companies. As a result, the measurement devices 220A-220E may have names that are not identical to or correlated with the names of the power system nodes 201-210. As further described herein, the system can perform automated tag mapping to correlate the measurement devices 220A-220E with corresponding power system nodes 201-210.

Among other operations, described herein is an Enhanced Disturbance Management (EDM) component (e.g., module) that is operable to read (e.g., obtain) monitoring data, for example, Supervisory Control and Data Acquisition (SCADA) system data, PMU-based data, topology data, and the like, based on power flow measurements associated with measurement devices (e.g., PMUs, current sensors, voltage sensors, etc.) connected to an electrical power system (e.g., electric power system, electrical energy system, electric energy system, power grid system, etc.), wherein the monitoring data can comprise alarm data indicative of an electrical disturbance within the electrical power system, and topology data indicative of a topology of the electrical power system. The EDM component can be operable to correlate the alarm data, which can relate to, for example, an angle disturbance alarm, or, for example, a frequency disturbance alarm, with a change in the topology data.

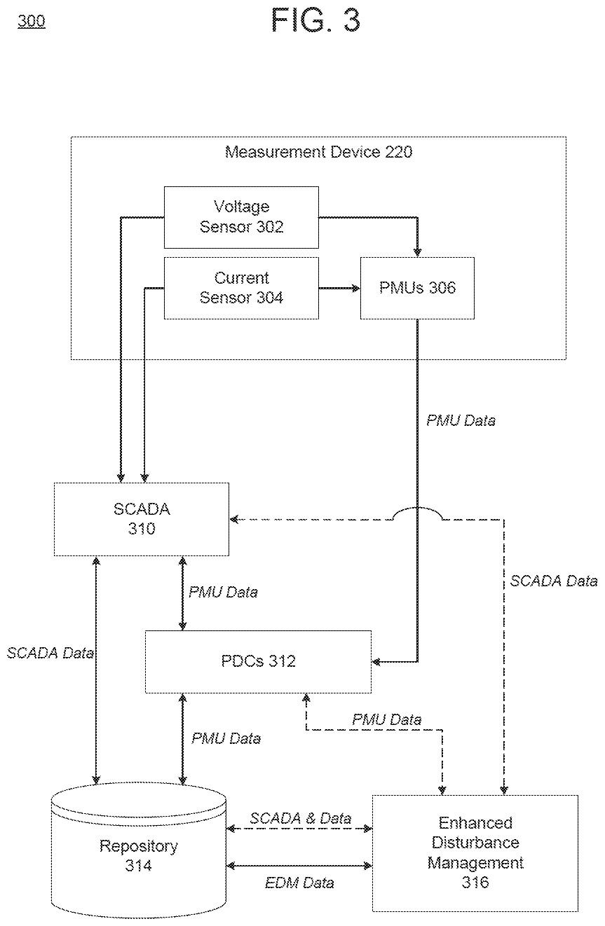

FIG. 3 illustrates a system 300 including an EDM module 316 in accordance with an example embodiment. In this example, the EDM module 316 can determine a characterization (e.g., classification, causation) of the electrical disturbance in the power grid system based on the correlating of the alarm data with the topology data, determining a coherency level representative of the degree of correlation between the alarm data and the topology data, determining a Disturbance Impact Factor (DIF) indicative of an impact of the electrical disturbance on a location in the power grid system, and identify one or more sensors (PMUs) that have captured data of the disturbance. The EDM module 316 can further auto-map PMUs to one or more power system nodes on the grid, retrieve power model information of the power system nodes, and validate the retrieved power model based on the PMU information of the disturbance. In some embodiments, the EMD module 316 can also store and display disturbance history, event history, and a variety of other statistical information related to disturbances and events, including on a graphical user interface, or in a generated report.

Measurement device 220 in FIG. 3 can obtain, monitor or facilitate the determination of electrical characteristics associated with the power grid system (e.g., the electrical power system), which can comprise, for example, power flows, voltage, current, harmonic distortion, frequency, real and reactive power, power factor, fault current, and phase angles. Measurement device 220 can also be associated with a protection relay, a Global Positioning System (GPS), a Phasor Data Concentrator (PDC), communication capabilities, or other functionalities.

Measurement devices 220 can provide real-time measurements of electrical characteristics or electrical parameters associated with the power grid system (e.g., the electrical power system). The measurement device 220 can, for example, repeatedly obtain measurements from the power grid system (e.g., the electrical power system) that can be used by the EDM module 316. The data generated or obtained by the measurement device 220 can be coded data (e.g., encoded data) associated with the power grid system that can input (or be fed into) a traditional SCADA/EMS system. The measurement device 220 can also be a PMU that repeatedly obtains subs-second measurements (e.g., 30 times per second). Here, the PMU data can be fed into, or input into, applications (e.g., Wide Area Monitoring System (WAMS) and WAMS-related applications) that can utilize the more dynamic PMU data (explained further below).

In the example of FIG. 3, the measurement device 220 includes a voltage sensor 302 and a current sensor 304 that feed data typically via other components, to, for example, a Supervisory Control and Data Acquisition (SCADA) system (e.g., SCADA component 310). Voltage and current magnitudes can be measured and reported to a system operator every few seconds by the SCADA component 310. The SCADA component 310 can provide functions such as data acquisition, control of power plants, and alarm display. The SCADA component can also allow operators at a central control center to perform or facilitate management of energy flow in the power grid system. For example, operators can use a SCADA component (for example using a computer such as a laptop or desktop) to facilitate performance of certain tasks such opening or closing circuit breakers, or other switching operations that might divert the flow of electricity.

In some examples, the SCADA component 310 can receive measurement data from Remote Terminal Units (RTUs) connected to sensors in the power grid system, Programmable Logic Controllers (PLCs) connected to sensors in the power grid system, or a communication system (e.g., a telemetry system) associated with the power grid system. PLCs and RTUs can be installed at power plants, substations, and the intersections of transmission and distribution lines, and can be connected to various sensors, including the voltage sensor 302 and the current sensor 304. The PLCs and RTUs receive its data from the voltage and current sensors to which they are connected. The PLCs and RTUs can convert the measured information to digital form for transmission of the data to the SCADA component. In example embodiments, the SCADA component 310 can also comprise central host server or servers called master terminal units (MTUs), sometimes also referred to as a SCADA center. The MTU can also send signals to PLCs and RTUs to control equipment through actuators and switchboxes. In addition, the MTU can perform controlling, alarming, and networking with other nodes, etc. Thus, the SCADA component 310 can monitor the PLCs and RTUs, and can send information or alarms back to operators over telecommunications channels.

The SCADA component 310 can also be associated with a system for monitoring or controlling devices in the power grid system, such as an Energy Management System (EMS). An EMS can comprise one or more systems of computer-aided tools used by operators of the electric power grid systems to monitor, control, and optimize the performance of the generation or transmission system. Often, an EMS is also referred to as SCADA/EMS or EMS/SCADA. In these respects, the SCADA/EMS or EMS/SCADA can also perform the functions of a SCADA. Or, a SCADA can be operable to send data (e.g., SCADA data) to the EMS, which can in turn provide the data to the EDM module 316. Other systems with which the EDM module 316 can be associated can comprise a situational awareness system for the power grid system, a visualization system for the power grid system, a monitoring system for the power grid system or a stability assessment system for the power grid system.

The SCADA component 310 can generate or provide SCADA data (e.g., SCADA DATA shown in FIG. 3) comprising, for example, real-time information (e.g., real-time information associated with the devices in the power grid system) or sensor information (e.g., sensor information associated with the devices in the power grid system) that can be used by the EDM module 316. The SCADA data can be stored, for example, in a repository 314 (described further below). In example embodiments, data determined or generated by the SCADA component 310 can be employed to facilitate generation of topology data (topology data is further described below) that can be employed by the EDM module 316 for enhanced disturbance management, which is further described below.

The employment of current sensor 304 and voltage sensor 302 allow for fast response. Traditionally, the SCADA component 310 monitors power flow through lines, transformers, and other components relies on the taking of measurements every two to six seconds, and cannot be used to observe the dynamic characteristics of the power system because of its slow sampling rate (e.g., cannot detect the details of transient phenomena that occur on timescales of milliseconds (one 60 Hz cycle is 16 milliseconds). Additionally, although SCADA technology enables some coordination of transmission among utilities, the process can be slow, especially during emergencies, with much of the response based on telephone calls between human operators at the utility control centers. Furthermore, most PLCs and RTUs were developed before industry-wide standards for interoperability were established, and as such, neighboring utilities often use incompatible control protocols.

The measurement device 220 also includes one or more PMUs 306. A PMU 306 can be a standalone device or may be integrated into another piece of equipment such as a protective relay. PMUs 306 can be employed at substations, and can provide input into one or more software tools (e.g., WAMS, SCADA, EMS, and other applications). A PMU 306 can use voltage and current sensors (e.g., voltage sensors 302, current sensors 304) that can measure voltages and currents at principal intersecting locations (e.g., substations) on a power grid using a common time source for synchronization, and can output accurately time-stamped voltage and current phasors. The resulting measurement is often referred to as a synchrophasor (although the term synchrophasor refers to the synchronized phasor measurements taken by the PMU 306, some have also used the term to describe the device itself). Because these phasors are truly synchronized, synchronized comparison of two quantities is possible in real time, and this time synchronization allows synchronized real-time measurements of multiple remote measurement points on the grid.

In addition to synchronously measuring voltages and currents, phase voltages and currents, frequency, frequency rate-of-change, circuit breaker status, switch status, etc., the high sampling rates (e.g., 30 times a second) provides “sub-second” resolution in contrast with SCADA-based measurements. These comparisons can be used to assess system conditions-such as: frequency changes, power in megawatts (MW), reactive power in mega volt ampere reactive (MVARs), voltage in kilovolts (KV), etc. As such, PMU measurements can provide improved visibility into dynamic grid conditions and can allow for real-time wide area monitoring of power system dynamics. Further, synchrophasors account for the actual frequency of the power delivery system at the time of measurement. These measurements are important in alternating current (AC) power systems, as power flows from a higher to a lower voltage phase angle, and the difference between the two relates to power flow. Large phase angle differences between two distant PMUs can indicate the relative stress across the grid, even if the PMUs are not directly connected to each other by a single transmission line. This phase angle difference can be used to identify power grid instability, and a PMU can be used to generate an angle disturbance alarm (e.g., angle difference alarm) when it detects a phase angle difference.

Examples of disturbances that might cause the generation of an angle disturbance alarm can comprise, for example, a line out or line in disturbance (e.g., a line out disturbance in which a line that was in service has now gone out of service, or in the case of a line in disturbance, in which case a line that was out of service has been brought back into service). PMUs 306 can also be used to measure and detect frequency differences, resulting in frequency alarms being generated. As an example, unit out and unit in disturbances can result in the generation of a frequency alarm (e.g., a generating unit was in service, but might have gone out of service, or a unit that was out of service has come back in to service—both can cause frequency disturbances in the system that can result in the generation of a frequency alarm.). Still yet, PMUs 306 can also be used to detect oscillation disturbances (e.g., oscillation in the voltage, frequency, real power—any kind of oscillation), which can result in the generation of an alarm (e.g., oscillation alarm). Several other types of alarms can be generated based on PMU data from PMU based measurements. Although the disturbances mentioned (e.g., line in/out, unit in/out, load in/out) can result in angle or frequency disturbance alarms, an angle or frequency disturbance alarm might not necessarily mean that a particular type of disturbance occurred, only that it is indicative of that type of disturbance. For example, if a frequency disturbance alarm is detected, it might not necessarily be a unit in or unit out disturbance, but may be a load in or load out disturbance. The measurement requirements and compliance tests for a PMU 306 have been standardized by the Institute of Electrical and Electronics Engineers (IEEE), namely IEEE Standard C37.118.

In the example of FIG. 3, one or more Phasor Data Concentrators (PDCs) 312 are shown, which can comprise local PDCs at a substation. Here, PDCs 312 can be used to receive and time-synchronized PMU data from multiple PMUs 306 to produce a real-time, time-aligned output data stream. A PDC can exchange phasor data with PDCs at other locations. Multiple PDCs can also feed phasor data to a central PDC, which can be located at a control center. Through the use of multiple PDCs, multiple layers of concentration can be implemented within an individual synchrophasor data system. The PMU data collected by the PDC 312 can feed into other systems, for example, a central PDC, corporate PDC, regional PDC, the SCADA component 310 (optionally indicated by a dashed connector), energy management system (EMS), synchrophasor applications software systems, a WAMS, the EDM module 316, or some other control center software system. With the very high sampling rates (typically 10 to 60 times a seconds) and the large number of PMU installations at the substations that are streaming data in real time, most phasor acquisition systems comprising PDCs are handling large amounts of data. As a reference, the central PDC at Tennessee Valley Authority (TVA), is currently responsible for concentrating the data from over 90 PMUs and handles over 31 gigabytes (GBs) of data per day.

In this example, the measurement device 220, the SCADA component 310, and PDCs/Central PDCs 312, can provide data (e.g., real-time data associated with devices, meters, sensors or other equipment in the power grid system) (including SCADA data and topology data), that can be used by the EDM module 316 for enhanced disturbance management. Both SCADA data and PMU data can be stored in one or more repositories 3014. In some example embodiments, the SCADA data and PMU data can be stored into the repository 314 by the SCADA component 310, or by the PDC 412. In other embodiments, the EDM module 316 can have one or more components or modules that are operable to receive SCADA data and PMU data and store the data into the repository 314 (indicated by dashed lines). The repository can comprise a local repository, or a networked repository. The data on the repository 314 can be accessed by SCADA component 310, the PDCs 312, others systems (not shown), and optionally by example embodiments of the EDM module 316. In example embodiments, the EDM module 316 can be operable to send instructions to one or more other systems (e.g., SCADA component 310, PDCs 312) to retrieve data stored on the repository 314 and provide it to the EDM module 316. In other embodiments, the EDM module 316 can facilitate retrieval of the data stored in repository 314, directly.

In example embodiments, the data stored in the repository 314 can be associated SCADA data and PMU data. The data can be indicative of measurements by measurement device 220 that are repeatedly obtained from a power grid system. In example embodiments, the data in repository 314 can comprise PMU/SCADA-based equipment data, such as, for example, data associated with a particular unit, line, transformer, or load within a power grid system (e.g., power grid system 200). The data can comprise voltage measurements, current measurements, frequency measurements, phasor data (e.g., voltage and current phasors), etc. The data can be location-tagged. For example, it can comprise a station identification of a particular station in which a power delivery device being measured is located (e.g., “CANADA8”). The data can comprise a particular node number designated for a location. The data can comprise the identity of the measure equipment (e.g., the identification number of a circuit breaker associated with an equipment). The data can also be time-tagged, indicating the time at which the data was measured by a measurement device. The PMU/SCADA-based equipment data can also contain, for example, information regarding a particular measurement device (e.g., a PMU ID identifying the PMU from which measurements were taken).

In example embodiments, the data stored in repository 314 can comprise not only collected and measured data from various measurement devices 220, but also data derived from that collected and measured data. The data derived can comprise topology data (e.g., PMU/SCADA-based topology data), event data, and event analysis data, and EDM data (data generated by EDM module 316).

In example embodiments, the repository 314 can contain topology data (e.g., PMU/SCADA-based topology data) indicative of a topology for the power grid system 200. The topology of a power grid system can relate to the interconnections among power system components, such as generators, transformers, busbars, transmission lines, and loads. This topology can be obtained by determining the status of the switching components responsible for maintaining the connectivity status within the network. The switching components can be circuit breakers that are used to connect (or disconnect) any power system component (e.g., unit, line, transformer, etc.) to or from the rest of the power system network. Typical ways of determining topology can be by monitoring of the circuit breaker status, which can be done using measurement devices and components associated with those devices (e.g., RTUs, SCADA, PMUs). It can be determined as to which equipment has gone out of service, and actually, which circuit breaker has been opened or closed because of that equipment going out of service.

The topology data can be indicative of an arrangement (e.g., structural topology, such as radial, tree, etc.) or a power status of devices in the power grid system. Connectivity information or switching operation information originating from one or more measurement devices 220 can be used to generate the topology data. The topology data can be based on a location of devices in the power grid system, a connection status of devices in the power grid system or a connectivity state of devices in the power grid system (e.g., devices that receive or process power distributed in throughout the power grid system, such as transformers and breakers). For example, the topology data can indicate where devices are located, and which devices in the power grid system are connected to other devices in the power grid system (e.g., where devices in the power grid system are connected, etc.) or which devices in the power grid system are associated with a powered grid connection. The topology data can further comprise the connection status of devices (e.g., a transformer, etc.) that facilitate power delivery in the power grid system, and the statuses for switching operations associated with devices in the power grid system (e.g., an operation to interrupt, energize or de-energize or connect or disconnect) a portion of the power grid system by connecting or disconnecting one or more devices in the power grid system (e.g., open or close one or more switches associated with a device in the power grid system, connect or disconnect one or more transmission lines associated with a device in the power grid system etc.). Furthermore, the topology data can provide connectivity states of the devices in the power grid system (e.g., based on connection points, based on busses, etc.).

In example embodiments, the repository 314 can contain a variety of event and event analysis data, which can be derived based on PMU data, and in some embodiments, other data as well (e.g., SCADA data, other measurement data, etc.). The data can comprise information regarding events related to the power grid system 200. An event can comprise, for example, one or more disturbances to the power grid system. A disturbance can comprise, for example, a line disturbance (e.g., line in, or line out), a unit disturbance (e.g., unit in or unit out), or load disturbance (load in or load out). For each event, relevant information such as the station where the event occurred, the voltage level associated with the station (e.g., 500 kV), the node number related to the event, the equipment related to the event, the change in real and reactive power, and change in voltage per unit for the event. The event and event analysis data can also comprise EDM data, which can be data related to events. The various data stored in the repository 314, including equipment data, topology data, event data, event analysis data, EDM data, and other data, can be inputs into the various functionalities and operations that can be performed by the EDM module 316.

Oscillations in the power grid reduce the stability of the grid because they cause changes (ups and downs) in the amount of power that is available on the grid. When an oscillation happens, it can be beneficial to detect the oscillation when it occurs, and to mitigate the oscillation in some way. In order to mitigate the oscillation, it is necessary to know the source location (i.e., source component on the grid) that is the cause of the oscillation. As will be appreciated, a power grid can include many different devices such as generators, transmission lines, etc., which generate power and/or carry the power. It is possible that many of these elements may be the cause/source of the oscillation. Therefore, identifying the source of the oscillation can be very difficult when dealing with a large power grid such as those that cover entire cities, states, and even countries.

The example embodiments use a two-step approach to find/locate the source of a power grid oscillation. In the first step, a small set of potential candidates for the source of the power grid oscillation are identified. Then, in a second step, a candidate (or multiple candidate) source locations are selected by the system as the source location of the oscillation. On the first step, machine learning may be used to identify a small list of candidates, for example, a bus or a few buses including a plurality of components that are connected to the bus/buses. Then, in the second step, an optimization model may be applied to the candidate set to identify a particular component (or two components, etc.) that are the actual source from the set of candidates identified using machine learning. In this way, the granularity of the optimization model is more refined than the granularity of the one or more machine learning models.

The system may use real-time data measured from the grid as inputs to the two-step software. The input data may include PMU data, MMU data, network model, dynamic power system models, etc. The first and second steps use the same inputs, except for the second step includes the candidate set generated/resulting from the first step which are output by the machine learning model(s).

According to various embodiments, a machine learning model (ML) model can be trained to identify a source location of an oscillation in the power grid. The granularity of the trained ML model's output may be at the bus level or similar level. As a result, a candidate set (e.g., plurality of target components connected to the bus, etc.) may be output as possible candidates of the source location of the oscillation. Furthermore, an optimization model may be used to identify a particular candidate (component) from among the candidate set output by the ML model. Here, the granularity of the optimization model is more refined (smaller) than the ML model, and may output an identifier of a particular component that is the cause/source of the oscillation. The ML model and the optimization model are further described below.

Training the ML model may be performed based on a power system simulator that simulates many possible oscillations (which are known), and then inputs the simulated oscillations, including the known locations of the oscillations, into the ML model. Over time, the ML model becomes more accurate the more simulations that are performed and used to train the ML model.

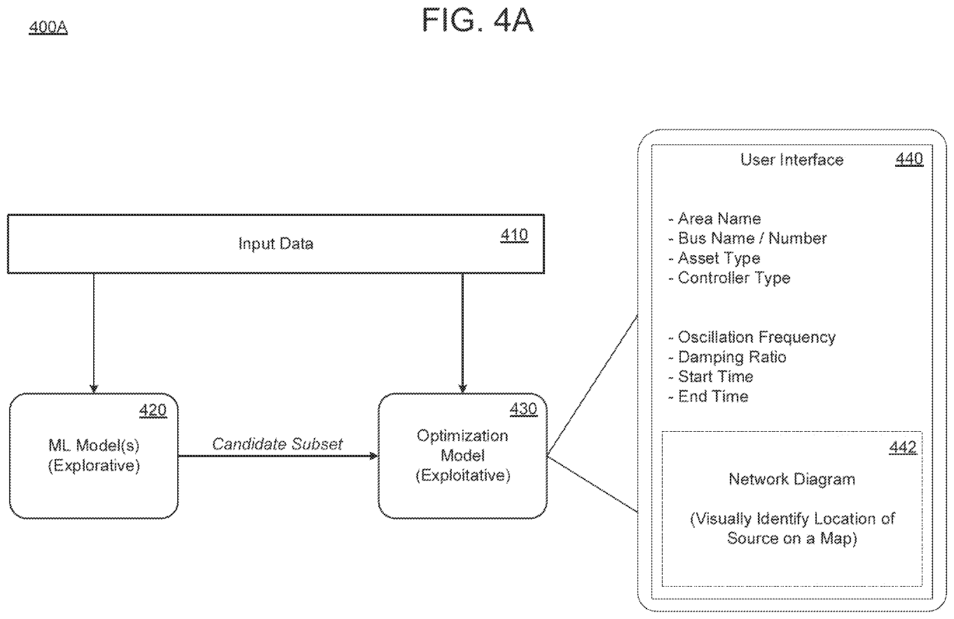

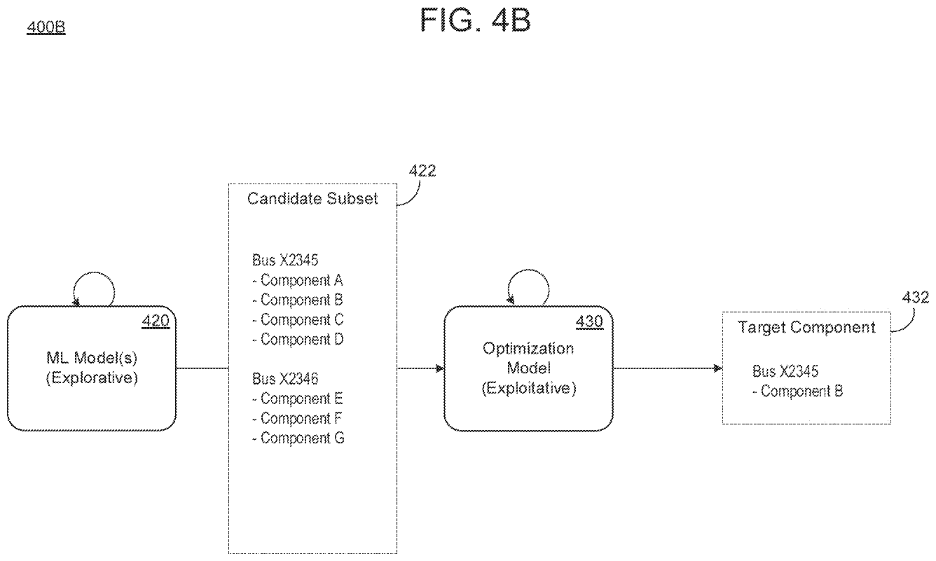

FIGS. 4A and 4B illustrate a two-step process 400A and 400B for identifying a source of an oscillation in a power system according to example embodiments. Here, the two step approach includes one or more ML models 420 and an optimization model 430. Any of the sensor data captured in the examples of FIGS. 2 and 3 can be used as inputs to the one or more ML models 420 and the optimization model 430.

Referring to FIG. 4A, input data 410 such as PMU data, WAMS data, MMU data, etc.) from any of the sensors described herein may be input into the one or more ML models 420 and the optimization model 430. It should be appreciated that other input data 410 may be input into the one or more ML models 420 and the optimization model 430 such as a network diagram (topology), dynamic power system models of the various components, and the like. Here, the input data 410 may include data of an oscillation within the power system.

The one or more ML models 420 may receive the input data 410 and predict a candidate set of components from the power system that are a source of the oscillation. The candidate set may be output from the one or more ML models 420 and input into the optimization model 430. In response, the optimization model 430 may identify a single target component (or possibly two or more components) that are the source of the oscillation from among the plurality of possible components in the candidate set generated by the one or more ML models 420.

Furthermore, the system may retrieve additional data on the identified component such as an identifier of the component, a bus name of the component, an asset type of the component (e.g., generator, load, HVDC, STATCOM, etc.), and the like and display this information via user interface 440. The system may also receive characteristics of the oscillation such as the oscillation frequency, the damping ratio, a start time of the oscillation, an end time of the oscillation, etc. and display this information via the user interface 440. Furthermore, the system may retrieve a network diagram 442 such as a topology of the power system, and display a visual identifier (e.g., highlighting, arrows, text, etc.) next to or on top of the representation of the identified component within the network diagram 442.

FIG. 4B illustrates an example of a candidate set 422 that may be generated by and output from the one or more ML models 420 and a target identified component 432 that is output by the optimization model 430. In this example, the candidate set 422 includes a rough estimation/approximation of the location of the oscillation source. Here, the one or more ML models 420 predict a combination of two buses which have seven power components connected thereto in the power system. The target component 432 that is output by the optimization model 430 refines the candidate set 422 down to a single bus and a single component.

Thus, an “explorative and exploitative” approach for power system oscillation source location is provided. The one or more machine learning models and the optimization model may be hosted by a server, a gateway, a cloud, and the like, that is connected to the power grid. Here, the one or more machine learning models may create outputs that are fed as inputs by the host system into the optimization model. The one or more machine learning models and the optimization model may receive input data from the power grid, including WAMS (PMU, MMU, FDR), a grid network model, a grid dynamic model, and the like. One or more machine learning models may identify a rough range of potential sources of the oscillation (referred to herein as candidates).

Furthermore, prior to using the machine learning models, the models may be trained from simulation data that includes simulated oscillations on the power grid. These simulations may be generated by a power system simulator software. For example, a physics-based simulator may be used to simulate a plurality of power oscillations on the power grid and the system may use these simulation results as training data for training the machine learning model(s). Thus, a combination of a physics-based model and a machine learning model can be used to form a model ensemble.

Next, the optimization model may pinpoint an exact source from among the rough range of potential sources. The machine learning models may include physics-based informed machine learning models, damping torque models, mode shape models, a combination of models, and the like. Meanwhile, the optimization model may be a structural and parameter co-search based on a design of experiment power simulations, such as singular value decomposition (SVD), similarity based source location, NLS optimization based method, Kalman filter based method, Multi-objective optimization, and the like.

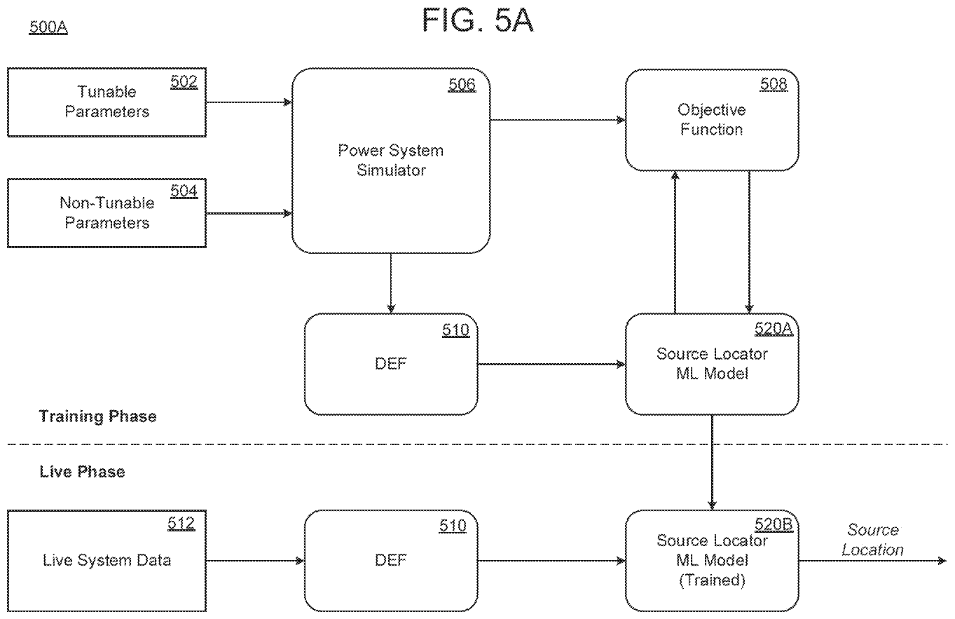

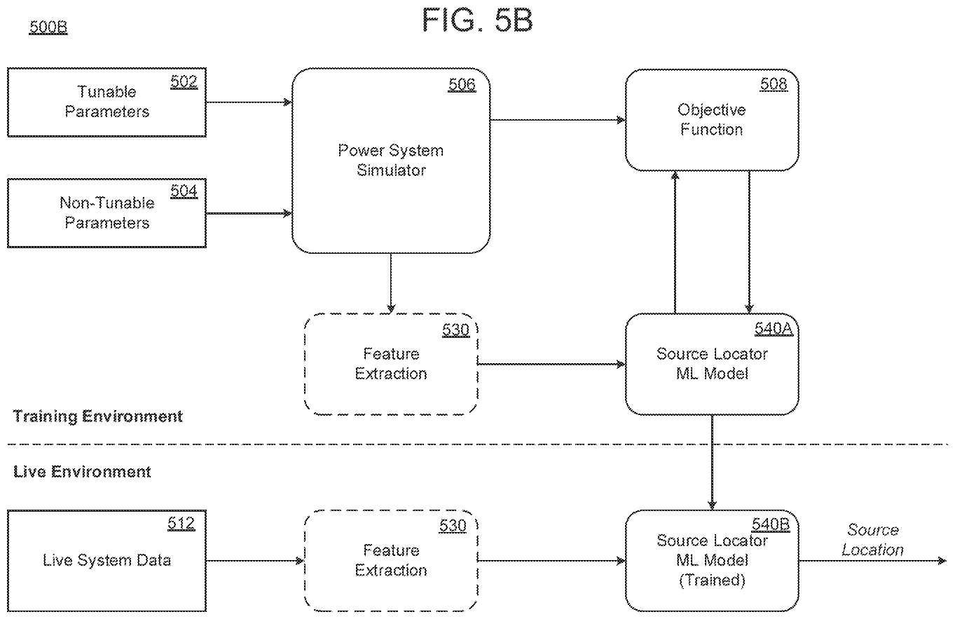

FIG. 5A illustrates a process 500A of training and deploying an oscillation source location identifying machine learning model in accordance with an example embodiment. Here, the trained model may be incorporated into the one or more ML models 420 shown in FIGS. 4A and 4B.

Referring to FIG. 5A, a training phase is shown on the top of the page and a live phase is shown on the bottom of the page. During the training phase, an oscillation source location identifying ML model 520A is trained based on simulations of oscillations that are performed by a power system simulator 506. Here, the training may include a DEF module 510 that includes one or more algorithms for identifying a ranked dissipated energy flow (DEF) that is also input to the ML model 520A during training (e.g., iteratively executing the machine learning model 520A on different training data sets, etc.) The power system simulator 506 may receive both tunable parameters 502 and non-tunable parameters 504 when simulating the oscillations. The ML model 520A may also be trained based off of an objective function 508 that provides a specification of the problem to be solved by the model, which in this case is identifying the source location of an oscillation in the power grid.

When the developer of the ML model 520A is satisfied, the ML model 520A may be packaged into an executable and installed on a host system as shown in the live phase. Here, the trained ML model 520B is executing on live data 512 from the power system. In this example, the same DEF module 510 may be used to add DEF data to the power system data. The trained ML model 520B may be used to identify a candidate set of locations as the source of an oscillation in the power grid.

Referring to FIG. 5B, an alternate process 500B of training and deploying an oscillation source location identifying machine learning model according to example embodiments. In this example, instead of a DEF module 510, the architecture includes a feature extraction model 530 that can identify features within the simulated oscillation data which can be used to train a ML model 540A. Once trained, the ML model 540b may identify source locations of oscillations in the power system from live data 512 of the power system. Here, the trained ML model 540B may also receive feature data from the feature extraction model 530.

According to various embodiments, the trained source locator model (e.g., source locator ML models 520b and 540b), may be used by itself to identify the set of candidate source locations of an oscillation. However, in some embodiments, the trained source locator model may be used in combination with other ML models.

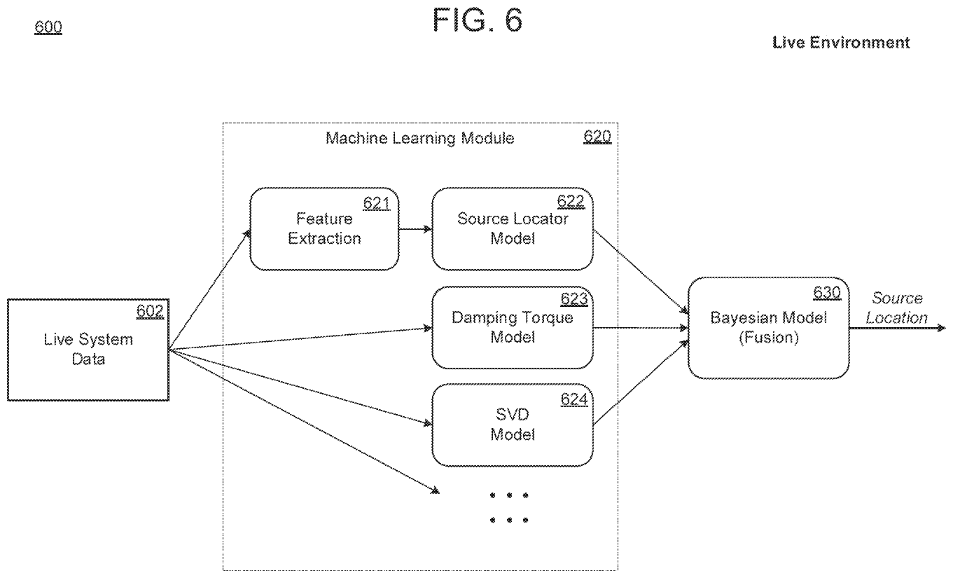

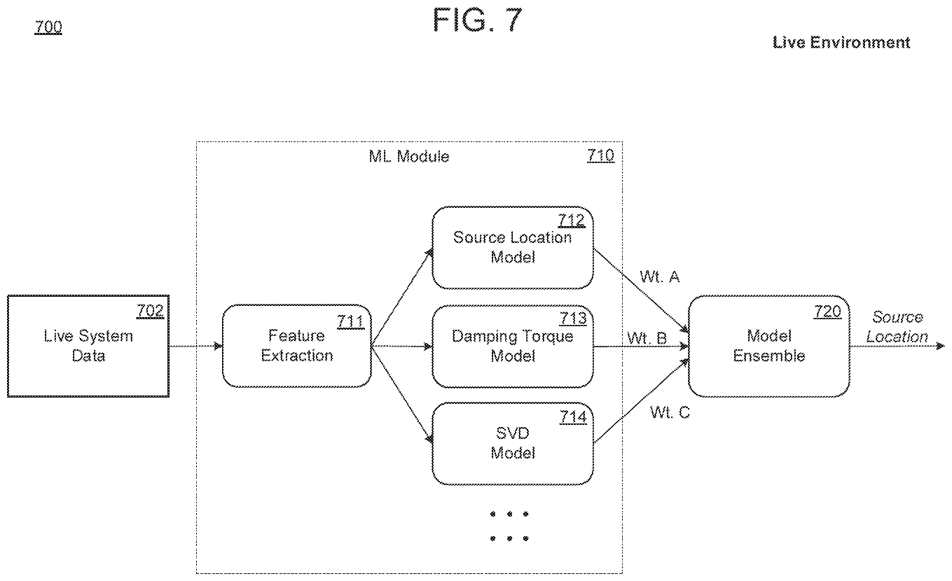

FIGS. 6 and 7 illustrate various examples of machine learning architectures 600 and 700 in accordance with example embodiments. Referring to FIG. 6, the architecture 600 includes a source locator model 620 that corresponds to the one or more trained ML model 520b and 540b shown in FIGS. 5A and 5B. Meanwhile, the machine learning module 620 may correspond to the one or more ML models 420 in FIGS. 4A and 4B.

Referring to FIG. 6, a source locator model 622 may be trained to identify a set of candidate locations of an oscillation within a power grid that is detected from live power system data 602. Here, the set of candidate locations may refer to a small portion or subset of components on the grid that could be the source of the oscillation. The source locator model 622 may include a feature extraction model 621 providing features identified from the live system data 602 thereby providing additional input data for the source locator model 622 to consider. In addition, the machine learning module 620 may include other source locator models such as a damping torque model 623 and a SVD model 624, and others, which are arranged in parallel to the source locator model 622 and which also predict respective sets of candidate sources of the oscillation. Furthermore, a fusion model 630 such as a Bayesian fusion model, may be used to fuse together the different respective candidate sets created by the models 622, 623, and 624, to create an optimal set of candidate source locations of the oscillation.

Referring to FIG. 7, a plurality of ML models 712, 713, and 714 (including a source locator 712) are arranged in parallel to each other and predict respective sets of candidate sources of the oscillation from live system data 702. Here, a feature extraction model 711 may be used by all of the ML models 712, 713, and 714. Furthermore, each of the ML models 712, 713, and 714 may have different weights (A, B, and C, respectively) given to their predictions by a model ensemble algorithm 720 which generates the final set of candidates from the different respective sets output by the ML models 712, 713, and 714 and the weights to be applied thereto.

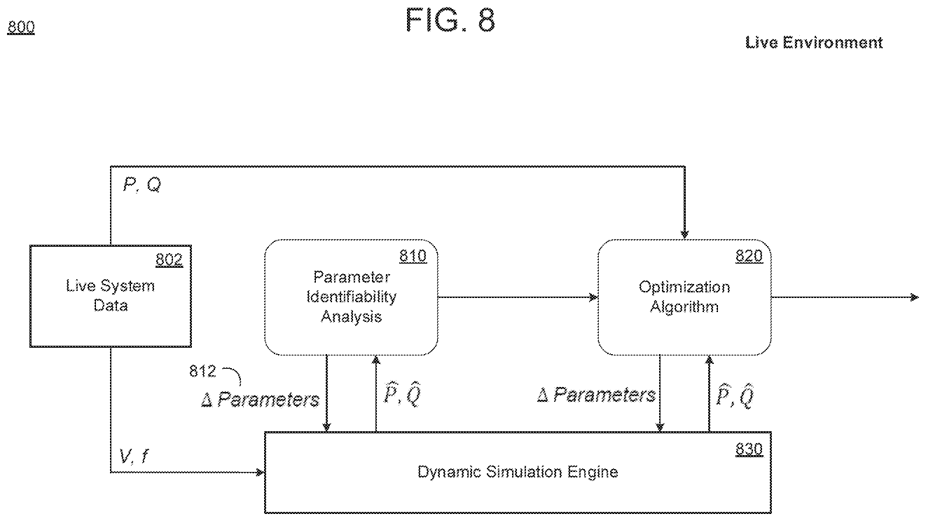

FIG. 8 illustrates an example of the optimization model 800 in accordance with an example embodiment. Referring to FIG. 8, the optimization model 800 may include a discrete and continuous parameter identifiability analysis module 810, an optimization algorithm 820, and a dynamic simulation engine 830. In this example, live system data 802 may be input into the optimization algorithm 820 and the dynamic simulation engine 830. Here, the parameter identifiability analysis module 810 identifies which parameters, for example, controller type/configuration, oscillatory frequency and magnitude, bus name/number, asset type, controller type, or the like, are the most optimum parameters for identifying the source of the oscillation.

Here, the parameter identifiability analysis module 810 can identify the parameter(s) and feed those to the optimization algorithm 820 which may perform a combinatory optimization on the live data based on the identified parameters. As an example, the optimization algorithm 820 may include a discrete and continuous parameter co-search algorithm. In this example, the parameters of the discrete and continuous parameter co-search algorithm may include a discrete parameter and a continuous parameter. As an example, the discrete parameter may include one or more of a name of an area (e.g., city, town, neighborhood, zip code, etc.), a bus name/number, an asset type (e.g., generator, load, HVDC, STATCOM, etc.), and a controller type. As an example, the continuous parameter may include an oscillation frequency, a damping ratio, a start time, an end time, and the like, of the oscillation which is being analyzed.

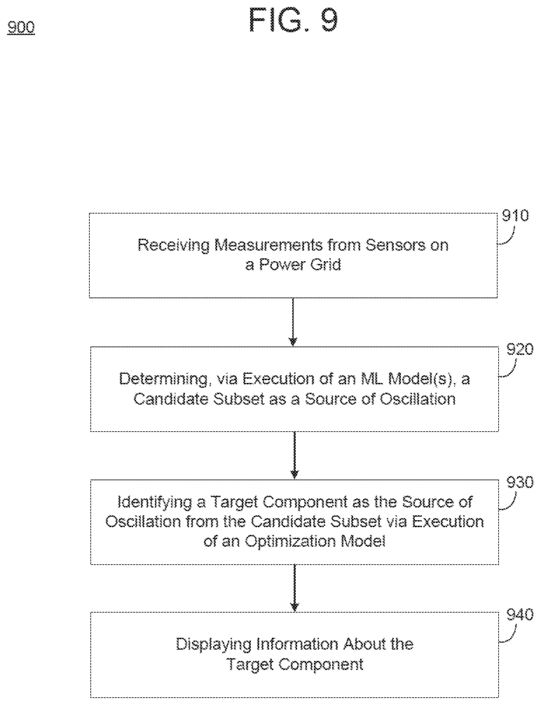

FIG. 9 illustrates a method 900 of identifying a source of an oscillation in a power system in accordance with an example embodiment. Referring to FIG. 9, in 910, the method may include receiving measurements from one or more sensors on a power grid, the measurements including data of an oscillation within the power grid. In 920, the method may include determining, via execution of one or more machine learning model, a candidate set of power system components disposed on the power grid that are candidates for being a source of the oscillation. In 930, the method may include identifying, via execution of an optimization model, a component from among the candidate set of power system components which is the source of the oscillation. In 940, the method may include displaying, via a user interface, information about the identified component.

In some embodiments, the determining the candidate set of power system components may include determining at least one bus on the power grid as the source of the oscillation via execution of the one or more machine learning models. In some embodiments, the identifying the component may include selecting a power system component from among a plurality of power system components that are attached to the determined at least one bus on the power grid, as the source of the oscillation via execution of the optimization model. In some embodiments, the identifying may include routing an output of the one or more machine learning models to an input of the optimization model.

In some embodiments, the method may further include simulating a plurality of oscillations on the power grid to generation simulation results and training the one or more machine learning models based on the simulation results. In some embodiments, the one or more machine learning models may include a feature extraction model which identifies features within the measurements, and a machine learning model which predicts the plurality of power system components based on the features identified by the feature extraction model.

In some embodiments, the one or more machine learning models may include a plurality of different machine learning models which generate a plurality of candidate sets of power system components as the source location of the oscillation, respectively, and a fusion model which combines the plurality of candidate sets of power system components to generate the candidate set. In some embodiments, the one or more machine learning models may include a plurality of different machine learning models which each predict a respective candidate set of power system components as the source location of the oscillation, and the method may further include assigning weights to the plurality of different machine learning models, and combining the respective candidate sets of power system components based on the assigned weights to generate the candidate set.

In some embodiments, the optimization model may include a discrete and continuous parameter co-search algorithm. In some embodiments, a discrete parameter of the discrete and continuous parameter co-search algorithm may include one or more of an area name, a bus name/number, a controller type, and an asset type. In some embodiments, a continuous parameter discrete and continuous parameter co-search algorithm comprises one or more of an oscillation frequency, a damping ratio, a start time, and an end time. In some embodiments, the discrete and continuous parameter co-search algorithm may include a combinatory optimization algorithm. In some embodiments, the discrete and continuous parameter co-search algorithm may include one or more of a Kalman filtering algorithm, a nonlinear least square algorithm, and an evolutional algorithm.

In some embodiments, the displaying may include displaying an identifier of a bus of the source of the oscillation, an identifier of the target component, a type of the target component, and a geographical area of the target component. In some embodiments, the displaying may further include displaying an oscillation frequency of the oscillation, a damping ratio, and a network diagram including an identifier of the target component within the network diagram. In some embodiments, the determining may further include determining the candidate set based on a dynamic power system model and a network model of the power grid.

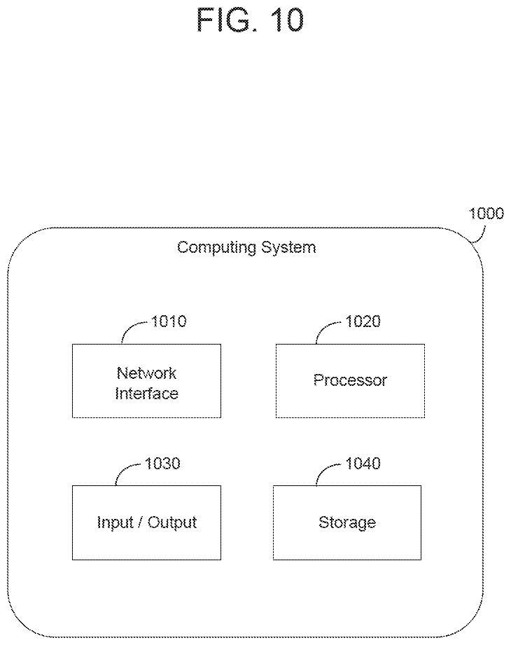

FIG. 10 illustrates a computing system 1000 that may be used in any of the methods and processes described herein, in accordance with an example embodiment. For example, the computing system 1000 may be a database node, a server, a cloud platform, or the like. In some embodiments, the computing system 1000 may be distributed across multiple computing devices such as multiple database nodes. Referring to FIG. 10, the computing system 1000 includes a network interface 1010, a processor 1020, an input/output 1030, and a storage device 1040 such as an in-memory storage, and the like. Although not shown in FIG. 10, the computing system 1000 may also include or be electronically connected to other components such as a display, an input unit(s), a receiver, a transmitter, a persistent disk, and the like. The processor 1020 may control the other components of the computing system 1000.

The network interface 1010 may transmit and receive data over a network such as the Internet, a private network, a public network, an enterprise network, and the like. The network interface 1010 may be a wireless interface, a wired interface, or a combination thereof. The processor 1020 may include one or more processing devices each including one or more processing cores. In some examples, the processor 1020 is a multicore processor or a plurality of multicore processors. Also, the processor 1020 may be fixed or it may be reconfigurable. The input/output 1030 may include an interface, a port, a cable, a bus, a board, a wire, and the like, for inputting and outputting data to and from the computing system 1000. For example, data may be output to an embedded display of the computing system 1000, an externally connected display, a display connected to the cloud, another device, and the like. The network interface 1010, the input/output 1030, the storage 1040, or a combination thereof, may interact with applications executing on other devices.

The storage device 1040 is not limited to a particular storage device and may include any known memory device such as RAM, ROM, hard disk, and the like, and may or may not be included within a database system, a cloud environment, a web server, or the like. The storage 1040 may store software modules or other instructions which can be executed by the processor 1020 to perform the method shown in FIG. 9. According to various embodiments, the storage 1040 may include a data store having a plurality of tables, records, partitions and sub-partitions. The storage 1040 may be used to store database records, documents, entries, and the like.

As will be appreciated based on the foregoing specification, the above-described examples of the disclosure may be implemented using computer programming or engineering techniques including computer software, firmware, hardware or any combination or subset thereof. Any such resulting program, having computer-readable code, may be embodied or provided within one or more non-transitory computer-readable media, thereby making a computer program product, i.e., an article of manufacture, according to the discussed examples of the disclosure. For example, the non-transitory computer-readable media may be, but is not limited to, a fixed drive, diskette, optical disk, magnetic tape, flash memory, external drive, semiconductor memory such as read-only memory (ROM), random-access memory (RAM), and/or any other non-transitory transmitting and/or receiving medium such as the Internet, cloud storage, the Internet of Things (IoT), or other communication network or link. The article of manufacture containing the computer code may be made and/or used by executing the code directly from one medium, by copying the code from one medium to another medium, or by transmitting the code over a network.

The computer programs (also referred to as programs, software, software applications, “apps”, or code) may include machine instructions for a programmable processor, and may be implemented in a high-level procedural and/or object-oriented programming language, and/or in assembly/machine language. As used herein, the terms “machine-readable medium” and “computer-readable medium” refer to any computer program product, apparatus, cloud storage, internet of things, and/or device (e.g., magnetic discs, optical disks, memory, programmable logic devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal that may be used to provide machine instructions and/or any other kind of data to a programmable processor.

The above descriptions and illustrations of processes herein should not be considered to imply a fixed order for performing the process steps. Rather, the process steps may be performed in any order that is practicable, including simultaneous performance of at least some steps. Although the disclosure has been described in connection with specific examples, it should be understood that various changes, substitutions, and alterations apparent to those skilled in the art can be made to the disclosed embodiments without departing from the spirit and scope of the disclosure as set forth in the appended claims.

1. A method comprising:
receiving measurements from one or more sensors on a power grid, the measurements comprising data of an oscillation within the power grid;
determining, via execution of one or more machine learning models, a candidate set of power system components disposed on the power grid that are candidates for being a source of the oscillation based on the received measurements;
identifying, via execution of an optimization model, a component from among the candidate set of power system components which is the source of the oscillation based on the received measurements; and
displaying, via a user interface, information about the identified component.

2. The method of claim 1, wherein the determining the candidate set of power system components comprises determining at least one bus on the power grid as the source of the oscillation via execution of the one or more machine learning models.

3. The method of claim 2, wherein the identifying the component comprises selecting a power system component from among a plurality of power system components that are attached to the determined at least one bus on the power grid, as the source of the oscillation via execution of the optimization model.

4. The method of claim 1, wherein the identifying comprises routing an output of the one or more machine learning models to an input of the optimization model.

5. The method of claim 1, wherein the method further comprises simulating a plurality of oscillations on the power grid to generation simulation results and training the one or more machine learning models based on the simulation results.

6. The method of claim 1, wherein the one or more machine learning models comprise a feature extraction model which identifies features within the measurements, and a machine learning model which predicts the plurality of power system components based on the features identified by the feature extraction model.

7. The method of claim 1, wherein the one or more machine learning models comprise a plurality of different machine learning models which generate a plurality of candidate sets of power system components as the source location of the oscillation, respectively, and a fusion model which combines the plurality of candidate sets of power system components to generate the candidate set.

8. The method of claim 1, wherein the one or more machine learning models comprise a plurality of different machine learning models which each predict a respective candidate set of power system components as the source location of the oscillation, and the method further comprises assigning weights to the plurality of different machine learning models, and combining the respective candidate sets of power system components based on the assigned weights to generate the candidate set.

9. The method of claim 1, wherein the optimization model comprises a discrete and continuous parameter co-search algorithm.

10. The method of claim 9, wherein a discrete parameter of the discrete and continuous parameter co-search algorithm comprises one or more of an area name, a bus name/number, a controller type, and an asset type.

11. The method of claim 9, wherein a continuous parameter discrete and continuous parameter co-search algorithm comprises one or more of an oscillation frequency, a damping ratio, a start time, and an end time.

12. The method of claim 9, wherein the discrete and continuous parameter co-search algorithm comprises a combinatory optimization algorithm.

13. The method of claim 9, wherein the discrete and continuous parameter co-search algorithm comprises one or more of a Kalman filtering algorithm, a nonlinear least square algorithm, and an evolutional algorithm.

14. The method of claim 1, wherein the displaying comprises displaying an identifier of a bus of the source of the oscillation, an identifier of the target component, a type of the target component, and a geographical area of the target component.

15. The method of claim 14, wherein the displaying further comprises displaying an oscillation frequency of the oscillation, a damping ratio, and a network diagram including an identifier of the target component within the network diagram.

16. The method of claim 1, wherein the determining further comprises determining the candidate set based on a dynamic power system model and a network model of the power grid.

17. A computing system comprising:
a processor configured to
receive measurements from one or more sensors on a power grid, the measurements comprising data of an oscillation within the power grid,
determine, via execution of one or more machine learning models, a candidate set of power system components disposed on the power grid that are candidates for being a source of the oscillation based on the received measurements,
identify, via execution of an optimization model, a component from among the candidate set of power system components which is the source of the oscillation based on the received measurements, and
display, via a user interface, information about the identified component.

18. The computing system of claim 17, wherein the processor is configured to determine at least one bus on the power grid as the source of the oscillation via execution of the one or more machine learning models.

19. The computing system of claim 17, wherein the processor is configured to select a power system component from among a plurality of power system components that are attached to the determined at least one bus on the power grid, as the source of the oscillation via execution of the optimization model.

20. A non-transitory computer-readable medium comprising instructions which when read by a processor cause a computer to perform a method comprising:
receiving measurements from one or more sensors on a power grid, the measurements comprising data of an oscillation within the power grid;
determining, via execution of one or more machine learning models, a candidate set of power system components disposed on the power grid that are candidates for being a source of the oscillation based on the received measurements;
identifying, via execution of an optimization model, a component from among the candidate set of power system components which is the source of the oscillation based on the received measurements; and
displaying, via a user interface, information about the identified component.
